(19) United States
(12) Patent Application Publication
(10) Pub. No.: US 2026/0219385 A1
(43) Pub. Date: Jul. 30, 2026

(54) SIGNAL PROCESSING APPARATUS, SIGNAL PROCESSING METHOD, AND NON-TRANSITORY COMPUTER READABLE MEDIUM

(71) Applicant: NEC Corporation, Tokyo (JP)

(72) Inventors: Yuki YAMAGUCHI, Tokyo (JP); Taichi TANAKA, Tokyo (JP); Masato TODA, Tokyo (JP)

(73) Assignee: NEC Corporation, Tokyo (JP)

(21) Appl. No.: 19/144,542

(22) PCT Filed: Jan. 9, 2024
(86) PCT No.: PCT/JP2024/000171

§ 371 Date: Jun. 30, 2025

(30) Foreign Application Priority Data
Jan. 10, 2023 (JP) 2023-001674

(51) Int. Cl. G01S 13/90; G06T 7/55

(52) U.S. Cl. CPC G01S 13/90; G06T 7/55; G06T 2207/10028

(57) ABSTRACT

This signal processing device comprises a simulated SAR image generation unit and an evaluation calculation unit. The simulated SAR image generation unit generates simulation information including: a simulated SAR image formed from prediction values of pixels predicted to be obtained when a target region is observed in a steady state; and prediction reliability information indicating the reliability of the prediction values of the pixels. The evaluation calculation unit uses the simulation information to determine the evaluation index whereby a target SAR image, which is an analysis target, is evaluated.

### TECHNICAL FIELD

The present invention relates to a signal processing apparatus, a signal processing method, and a recording medium.

### BACKGROUND ART

Various techniques for detecting a change in a target region by using a SAR image of the target region have been proposed (for example, PTL 1 to 5). Here, the SAR image is, for example, a complex image in which complex number values representing the amplitude and phase of a backscattering signal observed using a SAR (synthetic aperture radar) are included in each pixel value constituting the SAR image.

PTL 1 discloses an interference-type synthetic aperture radar device that emits radio waves from a flying object toward the ground, receives a reflected wave from the ground, and extracts a topographic variation. The interference-type synthetic aperture radar device includes two antennas, a transmission/reception unit, an image processing unit, an interference processing unit, and a topographic variation analysis processing unit.

In PTL 1, the two antennas emit radio waves to the ground and simultaneously receive reflected waves from the ground. The transmission/reception unit simultaneously outputs a transmission wave to the two antennas and simultaneously inputs a reception wave. The image processing unit performs SAR reproduction processing on a reception output signal from the transmission/reception unit. The interference processing unit outputs a three-dimensional image by causing interference between output signals from the image processing unit. The topographic variation analysis processing unit compares three-dimensional image data acquired in real time by the interference processing unit with three-dimensional image data of the same area, which has been previously acquired by the interference processing unit, thereby extracting a variation in terrain in real time.

For example, PTL 1 discloses that contour maps are obtained based on phase difference images for pieces of data acquired at different times, and a change is detected based on the contour maps related to the different times.

PTL 2 discloses a technique of generating a reproduced image by performing synthetic aperture processing on radar image data captured by a SAR (synthetic aperture radar mounted on an artificial satellite) using a radar analysis device, and analyzing a change in a ground surface by performing difference processing or the like on the obtained image.

In PTL 2, a difference calculation unit calculates a difference between a plurality of characteristic values (scattering intensity, amount of change in ground, and the like) representing a state of the ground surface as an image capturing target, by calculating a difference between backscatter intensities of microwaves.

PTL 3 discloses a computer-implemented method related to determining coherency between composite images having components of the phase and the amplitude. PTL 3 discloses that the coherency can be determined based on an amplitude component of an image.

PTL 4 discloses a method for detecting at least one target in an image (I) obtained by a SAR. This image (I) comprises a set of pixels having a magnitude assigned to each pixel.

PTL 5 discloses a method for processing synthetic aperture radar (SAR) image data including a plurality of frames for each of a plurality of image geometries. The method includes, for each image geometry, generating a plurality of change products by applying change detection to a frame related to the image geometry.

### CITATION LIST

### Patent Literature

PTL 1: JP 07-072244 A
PTL 2: WO 2008/016153 A1
PTL 3: European Patent Application Publication No. 3540462
PTL 4: U.S. Pat. No. 10,571,560
PTL 5: UK Patent Application Publication No. 2553284

### SUMMARY OF INVENTION

### Technical Problem

In general, for example, in a region where a signal-to-noise ratio (SNR) of a received signal for generating a SAR image is small, a received signal related to the region may greatly change due to an influence of noise or the like even if there is no change in the region.

However, PTL 1 to 5 do not have description regarding noise or the like included in a received signal for generating a SAR image. Therefore, in the techniques disclosed in PTL 1 to 5, there is a concern that the accuracy of detecting the change in a target region is reduced, for example, in a case where a received signal greatly changes due to the influence of noise or the like.

In view of the above-described problems, an object of the present invention is to provide a signal processing apparatus, a signal processing method, a program, and the like that achieve detection of a change in a target region by using a SAR image with high accuracy.

### Solution to Problem

According to an aspect of the present invention, there is provided a signal processing apparatus including
simulated SAR image generation means for generating simulation information including a simulated SAR image formed from a prediction value of each pixel predicted to be obtained in a case where a target region in a steady state is observed, and prediction reliability information indicating reliability of the prediction value of each pixel, and
evaluation calculation means for obtaining an evaluation index obtained by evaluating a target SAR image that is an analysis target, by using the simulation information.

According to another aspect of the present invention,
there is provided a signal processing method including
by one or more computers,
generating simulation information including a simulated SAR image formed from a prediction value of each pixel predicted to be obtained in a case where a target region in a steady state is observed, and prediction reliability information indicating reliability of the prediction value of each pixel, and
obtaining an evaluation index obtained by evaluating a target SAR image that is an analysis target, by using the simulation information.

According to still another aspect of the present invention,
there is provided a program for causing one or more computers to execute
generating simulation information including a simulated SAR image formed from a prediction value of each pixel predicted to be obtained in a case where a target region in a steady state is observed, and prediction reliability information indicating reliability of the prediction value of each pixel, and
obtaining an evaluation index obtained by evaluating a target SAR image that is an analysis target, by using the simulation information.

### Advantageous Effects of Invention

According to one aspect of the present invention, it is possible to detect a change in a target region by using a SAR image with high accuracy.

### BRIEF DESCRIPTION OF DRAWINGS

FIG. 1 is a diagram illustrating an outline of a signal processing apparatus according to a first example embodiment.

FIG. 2 is a diagram illustrating an outline of a signal processing method according to the first example embodiment.

FIG. 3 is a diagram illustrating a functional configuration example of the signal processing apparatus according to the first example embodiment.

FIG. 4 is a diagram illustrating a first example of simulation information according to the first example embodiment.

FIG. 5 is a diagram illustrating a second example of the simulation information according to the first example embodiment.

FIG. 6 is a diagram illustrating a physical configuration example of the signal processing apparatus according to the first example embodiment.

FIG. 7 is a flowchart illustrating an example of signal processing according to the first example embodiment.

FIG. 8 is a diagram illustrating an example of a display screen according to the first example embodiment.

FIG. 9 is a diagram illustrating a relationship between a correlation between a reflection intensity and a phase and a coherence value in a general coherent change detection technique.

FIG. 10 is a diagram illustrating an outline of a signal processing system SPS according to a second example embodiment.

FIG. 11 is a diagram illustrating a configuration example of the signal processing system SPS according to the second example embodiment.

FIG. 12 is a flowchart illustrating an example of signal processing according to the second example embodiment.

FIG. 13 is a diagram for describing an example of estimating a complex reflectivity distribution at an azimuth-range position by using SAR tomography.

FIG. 14 is a diagram illustrating a functional configuration example of an evaluation calculation unit according to a fourth example embodiment.

FIG. 15 is a flowchart illustrating a detailed example of an evaluation index acquisition process according to the fourth example embodiment.

FIG. 16 is a diagram illustrating a functional configuration example of an evaluation calculation unit according to a fifth example embodiment.

FIG. 17 is a flowchart illustrating a detailed example of an evaluation index acquisition process according to the fifth example embodiment.

### EXAMPLE EMBODIMENT

Hereinafter, example embodiments of the present invention will be described with reference to the drawings. In all the drawings, the same components are denoted by the same reference signs, and the description will be omitted as appropriate.

### First Example Embodiment

### (Outline)

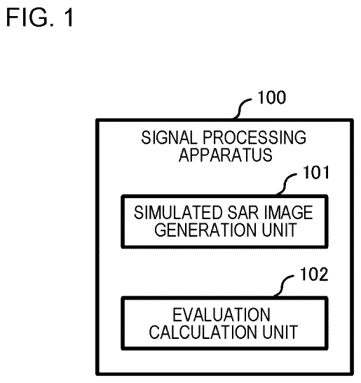

FIG. 1 is a diagram illustrating an outline of a signal processing apparatus 100 according to a first example embodiment. The signal processing apparatus 100 includes a simulated SAR image generation unit 101 and an evaluation calculation unit 102.

The simulated SAR image generation unit 101 generates simulation information including a simulated SAR image formed from a prediction value of each pixel predicted to be obtained in a case where a target region in a steady state is observed, and prediction reliability information indicating the reliability of the prediction value of the pixel.

The evaluation calculation unit 102 obtains an evaluation index obtained by evaluating a target SAR image that is an analysis target, by using the simulation information.

According to the signal processing apparatus 100, it is possible to detect a change in a target region by using a SAR image with high accuracy.

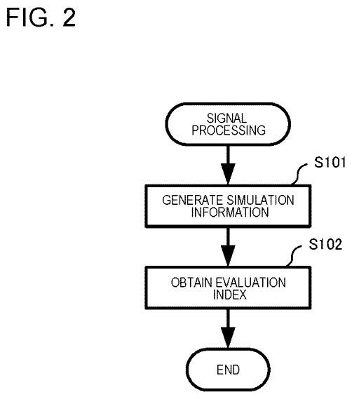

FIG. 2 is a diagram illustrating an outline of a signal processing method according to the first example embodiment.

The simulated SAR image generation unit 101 generates simulation information including a simulated SAR image formed from a prediction value of each pixel predicted to be obtained in a case where a target region in a steady state is observed, and prediction reliability information indicating the reliability of the prediction value of the pixel (Step S101).

The evaluation calculation unit 102 obtains an evaluation index obtained by evaluating a target SAR image that is an analysis target, by using the simulation information (Step S102).

According to the signal processing method, it is possible to detect a change in a target region by using a SAR image with high accuracy.

A detailed example of the signal processing apparatus 100 according to the first example embodiment will be described below.

### (Details)

(Functional Configuration Example of Signal Processing Apparatus 100 according to First Example Embodiment)

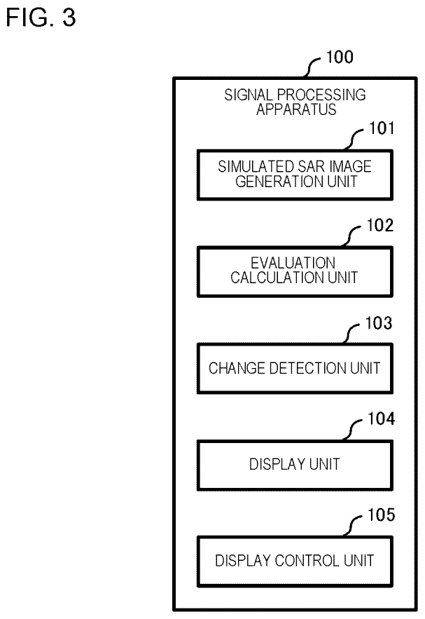

FIG. 3 is a diagram illustrating a functional configuration example of the signal processing apparatus 100 according to the first example embodiment. The signal processing apparatus 100 is an apparatus that detects a change in a target region by using a target SAR image that is an analysis target.

The target SAR image is an SAR image as an analysis target. The SAR image is a complex image in which complex number values representing a reflection intensity and a phase are included in each pixel value constituting the SAR image.

The target SAR image may be appropriately selected from observed SAR images, for example. In the present example embodiment, a case where there is one target SAR image will be described as an example. A plurality of target SAR images may be used.

An observed SAR image is a two-dimensional complex image generated based on a received signal of a flying object SAR (synthetic aperture radar) mounted on a flying object such as an artificial satellite or an aircraft. The received signal is, for example, a signal obtained by reflecting a transmission signal (for example, microwave) from the flying object SAR on the ground surface of the target region, and indicates an observation value including a reflection intensity component and a phase component. That is, the observed SAR image is a complex image including the observation value of each pixel obtained by actually observing the target region. The observation value of the observed SAR image is a complex number value including the reflection intensity component and the phase component.

The signal processing apparatus 100 includes a simulated SAR image generation unit 101, an evaluation calculation unit 102, a change detection unit 103, a display unit 104, and a display control unit 105.

The simulated SAR image generation unit 101 generates simulation information including the simulated SAR image and prediction reliability information indicating reliability of the simulated SAR image.

The simulated SAR image is a two-dimensional complex image including a prediction value of each pixel predicted to be obtained in a case where a target region in a steady state is observed under the same observation conditions as the target SAR image.

The observation conditions include at least one of the position of the flying object SAR when the observation value related to the target SAR image is observed, the coordinate position of the target region, the resolution, and the like.

The prediction value of each pixel corresponds to a pixel value of the simulated SAR image, and includes, for example, a complex number value representing the reflection intensity component and the phase component of the predicted received signal (that is, the prediction signal).

The steady state is a state in which there is no change in the target region or a state in which even if there is a change in the target region, the change cannot be detected.

The prediction reliability information is information indicating the reliability of the prediction value of each pixel constituting the simulated SAR image.

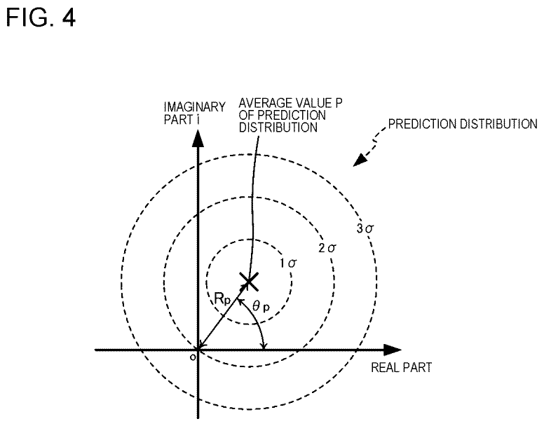

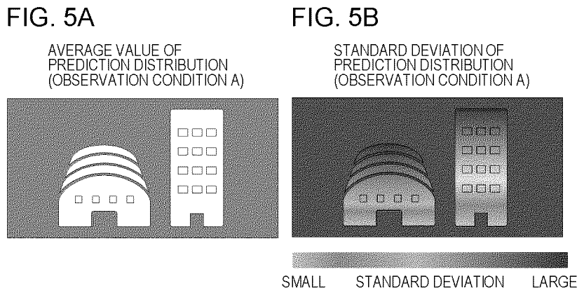

FIGS. 4 to 5 illustrate first and second examples of such simulation information. FIG. 5 is a diagram illustrating the second example of the simulation information according to the first example embodiment.

FIG. 4 is a diagram illustrating the first example of the simulation information according to the first example embodiment. This drawing illustrates prediction values and a prediction distribution associated with certain pixels included in the simulated SAR image. That is, this drawing is an example in which the prediction reliability information includes the prediction distribution (stochastic distribution of prediction values). The average value P of the prediction distribution illustrated in the drawing corresponds to the prediction value. For example, when the reflection intensity component is set as Rp and the phase component is set as θp, the average value P of the prediction distribution is expressed by Rpe^{iθp}. e is Napier's constant. j is an imaginary unit. The prediction distribution is a distribution indicated by dotted circles of 1σ, 2σ, and 3σ with the standard deviation as σ. A paper surface vertical direction is an axis indicating probability.

FIG. 5 is a diagram illustrating the second example of the simulation information according to the first example embodiment. Each of FIGS. 5(a) and 5(b) is a diagram illustrating the prediction value and a standard deviation of each pixel included in the simulated SAR image. This prediction value is, for example, the average value P of the prediction distribution. That is, this drawing is an example in which the prediction reliability information is a statistical index of the prediction distribution.

The prediction value may be a value other than the average value P of the prediction distribution. The prediction reliability information may include at least one of a prediction distribution indicating a stochastic distribution of the prediction value of each pixel, a statistical index of the prediction distribution, and a probability of the prediction value associated with each pixel. The statistical index may be, for example, at least one of an average value, a mode value, a variance, a standard deviation, a confidence interval, and the like.

Reference is made again to FIG. 3.

The evaluation calculation unit 102 obtains an evaluation index obtained by evaluating the target SAR image by using the simulation information generated by the simulated SAR image generation unit 101. That is, the evaluation calculation unit 102 obtains the evaluation index by using the simulated SAR image and the prediction reliability information.

The evaluation index is an index obtained by evaluating a target SAR image that is the analysis target. The evaluation index is, for example, an index obtained by probabilistically evaluating a degree to which an observation value constituting the target SAR image does not contradict a prediction value constituting the simulated SAR image. For example, the evaluation index is obtained for each corresponding pixel between the simulated SAR image and the target SAR image, and is typically plural.

The change detection unit 103 detects a change in the target region by using the evaluation index calculated by the evaluation calculation unit 102. Specifically, for example, in a case where the evaluation index is a numerical value, the change detection unit 103 detects a change in the target region based on a result of comparing the evaluation index with a predetermined threshold value.

The display unit 104 displays various types of information under the control of the display control unit 105. The display control unit 105 causes the display unit 104 to display, for example, the simulated SAR image, the target SAR image, the evaluation index, the detection result regarding the change in the target region, and the like.

The functional configuration example of the signal processing apparatus 100 according to the first example embodiment has been described above. A physical configuration example of the signal processing apparatus 100 according to the first example embodiment will be described below.

(Physical Configuration Example of Signal Processing Apparatus 100 according to First Example Embodiment)

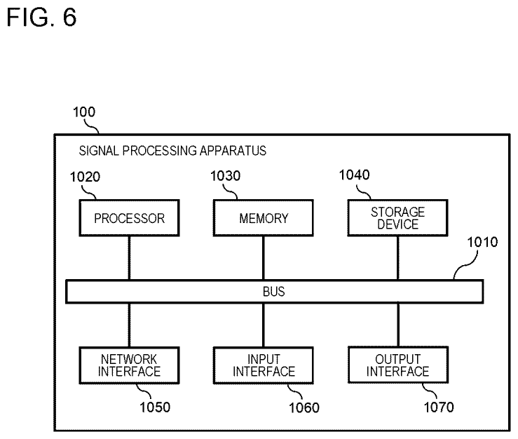

FIG. 6 is a diagram illustrating a physical configuration example of the signal processing apparatus 100 according to the first example embodiment. The signal processing apparatus 100 physically includes, for example, a bus 1010, a processor 1020, a memory 1030, a storage device 1040, a network interface 1050, an input interface 1060, and an output interface 1070.

The bus 1010 is a data transmission path through which the processor 1020, the memory 1030, the storage device 1040, the network interface 1050, the input interface 1060, and the output interface 1070 mutually transmit and receive data. The method of connecting the processor 1020 and the like to each other is not limited to the bus connection.

The processor 1020 is a processor achieved by a central processing unit (CPU), a graphics processing unit (GPU), or the like.

The memory 1030 is a main storage device achieved by a random access memory (RAM) or the like.

The storage device 1040 is an auxiliary storage device achieved by a hard disk drive (HDD), a solid state drive (SSD), a memory card, a read only memory (ROM), or the like. The storage device 1040 stores a program module for enabling a function of an apparatus including the storage device. The processor 1020 reads and executes the program module in the memory 1030, thereby enabling the functions related to the program modules.

The network interface 1050 is an interface for connecting the apparatus including the network interface to a network NT.

The input interface 1060 is an interface for the user to input information. The input interface 1060 includes, for example, a touch panel, a keyboard, a mouse, and the like.

The output interface 1070 is an interface for presenting information to the user. The output interface 1070 includes, for example, a liquid crystal panel, an organic electro-luminescence (EL) panel, or the like.

The configuration example of the signal processing apparatus 100 according to the first example embodiment has been described above. An operation example of the signal processing apparatus 100 according to the first example embodiment will be described below.

(Operation Example of Signal Processing Apparatus 100 according to First Example Embodiment)

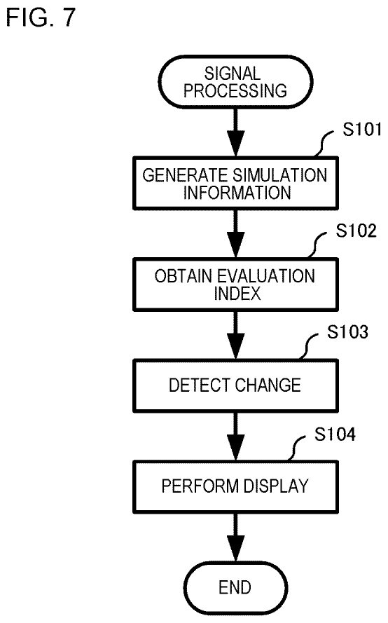

FIG. 7 is a flowchart illustrating an example of signal processing according to the first example embodiment. The signal processing is processing for detecting a change in a target region by using a target SAR image that is an analysis target. The signal processing apparatus 100 starts signal processing, for example, in response to an instruction received from a user. The instruction may include information for identifying the target SAR image.

The trigger for starting the signal processing is not limited to this. The signal processing may be repeatedly performed in real time on the target SAR image obtained by observing the target region.

### (Step S101: Example of Simulation Information Generation Process)

The simulated SAR image generation unit 101 generates simulation information (Step S101).

Specifically, for example, the simulated SAR image generation unit 101 acquires three-dimensional information with reliability, and generates simulation information by using the acquired three-dimensional information with reliability. As described above, the simulation information includes the simulated SAR image and the prediction reliability information indicating the reliability of the prediction value of each pixel constituting the simulated SAR image.

The three-dimensional information with reliability includes three-dimensional information and estimation reliability information indicating reliability of the three-dimensional information.

The three-dimensional information is information including a three-dimensional image. Specifically, for example, the three-dimensional information includes a three-dimensional complex image reconstructed using an observed SAR image in the steady state. A detailed example of such three-dimensional information with reliability will be described in other example embodiments.

Original information (generation source information) for generating the simulation information is not limited to the three-dimensional information with reliability. For example, the generation source information only needs to be information indicating the steady state of the target region, such as a steady state image based on observation of another flying object SAR. For example, the generation source information may include one or more of the temperature, the displacement, and the like of the target region.

Generally, the observed SAR image is obtained based on the observation of the flying object SAR as described above. The position of the flying object SAR changes from moment to moment, and a direction in which the flying object SAR observes the target region also changes. When the time point at which the observation value related to the observed SAR image is observed is different, observation conditions such as the position of the flying object SAR change. Therefore, when an observation time point is different, even if the target region in the steady state is observed, the observed SAR image slightly changes.

As can be seen from this, regarding detection of the change in the target region based on the target SAR image, it is difficult to accurately detect the change in the target region even though the target SAR image is compared with the observed SAR image obtained by observing the target region in the past.

In Step S101, the simulated SAR image generation unit 101 generates the simulated SAR image by using three-dimensional information (such as a three-dimensional image) generated using the observed SAR image in the steady state. As a result, it is possible to generate a simulated SAR image having the same observation conditions as the target SAR image.

The three-dimensional image includes a plurality of three-dimensional elements (also referred to as a “voxel” below), and includes a value (also referred to as “voxel value” below) associated with each of the plurality of voxels. The voxel value generally includes uncertainty due to SNR, a layover phenomenon, and the like. The layover phenomenon is a phenomenon in which the positional relationship is reversed between a high altitude place and a low altitude place in a SAR image. The layover phenomenon causes uncertainty occurring in a case where a three-dimensional image is generated by using an observed SAR image.

The three-dimensional information with reliability includes reliability information indicating the likelihood of such voxel values. The estimation reliability information described above is an example of the reliability information in a case where the voxel value is an estimated value described in other example embodiments.

Since the three-dimensional information with reliability includes the reliability information, the simulated SAR image generation unit 101 can generate the prediction reliability information indicating the reliability of the prediction value of each pixel constituting the generated simulated SAR image.

An example of the reliability information included in the reliable three-dimensional information with reliability is the above-described estimation reliability information. A detailed example of the estimation reliability information will be described in other example embodiments together with a detailed example of the three-dimensional information with reliability.

In a case where there are a plurality of target SAR images, the simulated SAR image generation unit 101 may generate a plurality of simulated SAR images having the same target conditions as each of the plurality of target SAR images. The simulated SAR image generation unit 101 generates a plurality of pieces of simulation information related to each of the plurality of target SAR images by generating the prediction reliability information related to each of the simulated SAR images.

### (Step S102: Example of Evaluation Index Acquisition Process)

The evaluation calculation unit 102 obtains an evaluation index obtained by evaluating the target SAR image by using the simulation information generated in Step S101 (Step S102).

Specifically, for example, the evaluation calculation unit 102 compares the target SAR image with the simulated SAR image (observation value and prediction value). The evaluation calculation unit 102 evaluates the change in the target SAR image with respect to the simulated SAR image by using the prediction reliability information in this comparison. As a result of the comparison, the evaluation calculation unit 102 obtains the evaluation index.

A detailed example of the evaluation index will be described in other example embodiments. The evaluation index only needs to be an index obtained by evaluating the target SAR image by using the simulation information, and is not limited to those exemplified in the present example embodiment, other example embodiments, and the like.

### (Step S103: Example of Change Detection Process)

The change detection unit 103 detects the change in the target region by using the evaluation index obtained in Step S103 (Step S103).

Specifically, for example, the change detection unit 103 compares the evaluation index with a threshold value. For example, in a case where the evaluation calculation unit 102 compares pixel values (prediction value and observation value) for each corresponding pixel in the target SAR image and the simulated SAR image in Step S102, the evaluation index for each pixel constituting the target SAR image is obtained. In this case, the change detection unit 103 compares each evaluation index with the threshold value for each pixel constituting the target SAR image. The threshold value may be determined in advance, and may be common to all pixels, for example.

For example, the change detection unit 103 determines that there is a change in a pixel whose evaluation index is equal to or less than the threshold value, and detects the change in a region related to the pixel in the target region. The method of detecting the change is not limited to this. For example, the change detection unit 103 may determine that there is a change in a pixel whose evaluation index is equal to or larger than the threshold value, and detect a change in a region related to the pixel in the target region.

The method of obtaining the evaluation index and the method of detecting the change described here are merely examples, and may be appropriately changed.

### (Step S104: Example of Display Process)

The display control unit 105 causes the display unit 104 to display a display screen (Step S104). The display screen includes, for example, the simulated SAR image obtained in each of Steps S101 to S103, the step evaluation index and the detection result, the target SAR image, and the like.

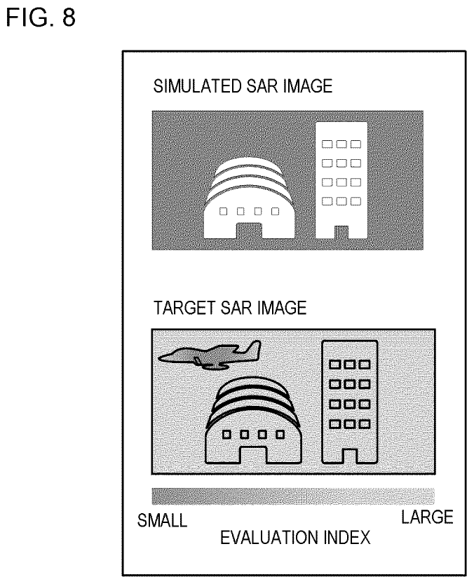

FIG. 8 is a diagram illustrating an example of the display screen according to the first example embodiment. The display screen illustrated in the drawing includes the simulated SAR image and the target SAR image. In the target SAR image, the evaluation index of each pixel obtained in Step S102 is represented by, for example, a color. By referring to this, a user can easily grasp the change that an airplane is observed in the target SAR image.

In the simulated SAR image and the target SAR image illustrated in FIG. 8, a change is detected in a region related to the airplane in Step S103, and thus the region may be highlighted in the target SAR image. For example, the display screen may include prediction reliability information and the like of each pixel. The display screen is not limited to this, and may be appropriately changed.

By performing this signal processing, the evaluation index of the target SAR image can be obtained using the simulated SAR image and the prediction reliability information. By performing displaying, the user can easily recognize various types of obtained information such as the evaluation index.

### (Operations and Effects)

As described above, according to the present example embodiment, the signal processing apparatus 100 includes the simulated SAR image generation unit 101 and the evaluation calculation unit 102. The simulated SAR image generation unit 101 generates simulation information including a simulated SAR image formed from a prediction value of each pixel predicted to be obtained in a case where a target region in a steady state is observed, and prediction reliability information indicating the reliability of the prediction value of the pixel. The evaluation calculation unit 102 obtains an evaluation index obtained by evaluating a target SAR image that is an analysis target, by using the simulation information.

As a result, the evaluation index of the target SAR image can be obtained using the simulated SAR image and the prediction reliability information. Therefore, the target SAR image can be evaluated in consideration of the reliability of the simulated SAR image. Thus, it is possible to detect a change in a target region by using a SAR image with high accuracy.

Here, in general, there is a coherent change detection technique as a technique for detecting a change by comparing two SAR images. The coherent change detection technique is a technique for detecting a minute change from the steady state based on a value of a complex correlation (coherence) indicating similarity between SAR images.

Generally, in a case where the coherence value is high, it is determined that the intensity and phase similarity between the SAR images is high and there is no change in a local region. In a case where the coherence value is low, it is determined that the intensity and phase similarity between the SAR images is low and a change has occurred in the local region. Such a coherence value can be said to be an index indicating a correlation between the reflection intensity and the phase in the local region between SAR images.

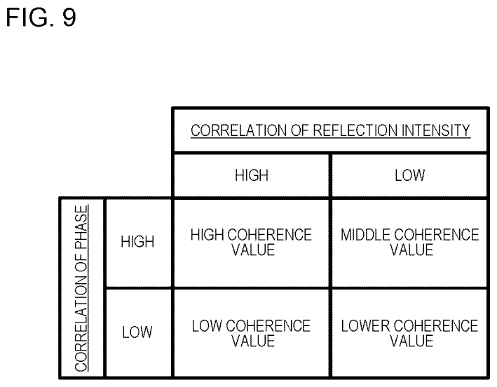

However, the coherence value tends to be more sensitive to a change in the phase than the reflection intensity. Therefore, as illustrated in FIG. 9, in a case where the phase correlation is low, the coherence value is low even if the correlation of the reflection intensity is high. FIG. 9 is a diagram illustrating a relationship between a correlation between the reflection intensity and the phase, and the coherence value in the general coherent change detection technique.

When such a coherence value is used, for example, in a region where the signal-to-noise ratio (SNR) is small, the coherence value tends to be low due to the influence of noise. Therefore, for example, even in a case where there is no change in this region, it may be erroneously determined that there is a change, in the general coherent change detection technique.

On the other hand, in the present example embodiment, as described above, the target SAR image can be evaluated in consideration of the reliability of the simulated SAR image, such as in a region with a low signal-to-noise ratio (SNR). For example, in a region where the signal-to-noise ratio (SNR) is small, the target SAR image can be evaluated in consideration of ambiguity of prediction values in the simulated SAR image related to the region. As a result, it is possible to obtain an evaluation index capable of accurately detecting a change in the region. Thus, it is possible to detect a change in the target region by using the SAR image with high accuracy.

According to the present example embodiment, each of the simulated SAR image and the target SAR image is a two-dimensional complex image.

A typical SAR image is a two-dimensional complex image. Therefore, with this configuration, it is possible to accurately detect the change in the target region by applying the configuration to a general SAR image.

According to the present example embodiment, the prediction value of each pixel is a complex number value including the reflection intensity component and the phase component predicted to be obtained in a case where a target region in the steady state is observed under the same observation conditions as in the target SAR image.

As a result, the observation conditions assumed in the simulated SAR image can be made the same as the observation conditions of the target SAR image, and thus it is possible to obtain a more accurate evaluation index. Thus, it is possible to detect a change in the target region by using the SAR image with high accuracy.

According to the present example embodiment, the prediction reliability information includes at least one of the prediction distribution indicating the probabilistic distribution of prediction values, the statistical index of the prediction distribution, and the probability of being the prediction value.

By using such prediction reliability information, the target SAR image can be evaluated in consideration of the reliability of the simulated SAR image. Thus, it is possible to detect a change in the target region by using the SAR image with high accuracy.

According to the present example embodiment, the target SAR image includes the observation value of each pixel obtained by actually observing the target region. There are a plurality of evaluation indices. The evaluation index is an index obtained by probabilistically evaluating a degree to which an observation value constituting the target SAR image does not contradict a prediction value constituting the simulated SAR image.

As a result, the target SAR image can be evaluated in consideration of the reliability of the simulated SAR image. Thus, it is possible to detect a change in the target region by using the SAR image with high accuracy.

According to the present example embodiment, the signal processing apparatus 100 further includes the change detection unit 103 that detects the change in the target region by using the evaluation index.

As a result, it is possible to automatically detect the change in the target region by using the evaluation index. Therefore, it is possible to easily know the change in the target region.

### Second Example Embodiment

In the present example embodiment, a detailed example of the three-dimensional information with reliability will be described. In the present example embodiment, an example in which three-dimensional information with reliability is generated using a plurality of observed SAR images obtained by observing a target region in the steady state will be described.

In the present example embodiment, in order to simplify the description, the description overlapping with the first example embodiment will be appropriately omitted.

### (Overview)

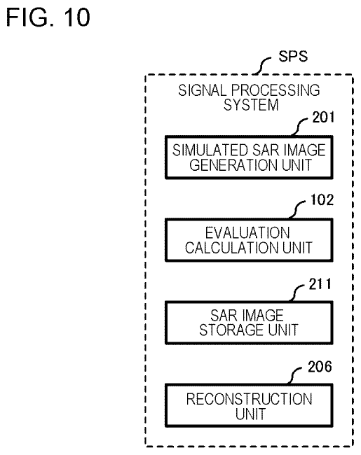

FIG. 10 is a diagram illustrating an outline of a signal processing system SPS according to a second example embodiment. The signal processing system SPS includes a simulated SAR image generation unit 101, an evaluation calculation unit 102, a SAR image storage unit 211, and a reconstruction unit 206.

The simulated SAR image generation unit 101 generates simulation information including a simulated SAR image formed from a prediction value of each pixel predicted to be obtained in a case where a target region in a steady state is observed, and prediction reliability information indicating the reliability of the prediction value of the pixel. The simulated SAR image generation unit 101 generates simulation information by using three-dimensional information with reliability and observation conditions in a case where an actual measured value is observed.

The evaluation calculation unit 102 obtains an evaluation index obtained by evaluating a target SAR image that is an analysis target, by using the simulation information.

The SAR image storage unit 211 is a storage unit that stores an observed SAR image of a target region including observation values obtained by observing the target region by using a synthetic aperture radar.

The reconstruction unit 206 generates the three-dimensional information with reliability including three-dimensional information and estimation reliability information, by using the plurality of observed SAR images.

The three-dimensional information includes an estimated value of each of the reflection intensity and the phase for each of three-dimensional elements constituting the target region.

The estimation reliability information indicates the reliability of the estimated value of each three-dimensional element.

According to the signal processing system SPS, it is possible to detect a change in a target region by using a SAR image with high accuracy.

A detailed example of the signal processing system SPS according to the second example embodiment will be described below.

### (Details)

(Configuration Example of Signal Processing System SPS according to Second Example Embodiment)

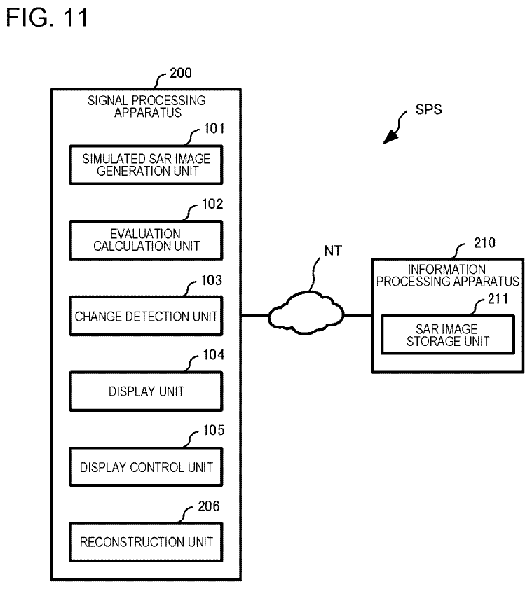

FIG. 11 is a diagram illustrating a configuration example of the signal processing system SPS according to the second example embodiment. The signal processing system SPS is a system that detects a change in a target region by using a target SAR image that is an analysis target. The signal processing system SPS includes a signal processing apparatus 200 and an information processing apparatus 210.

The signal processing apparatus 200 and the information processing apparatus 210 are connected to each other via a network NT configured in a wired manner, a wireless manner, or a combination of the wired manner and the wireless manner. The signal processing apparatus 200 and the information processing apparatus 210 mutually transmit and receive information via the network NT.

(Functional Configuration Example of Information Processing Apparatus 210 according to Second Example Embodiment)

The information processing apparatus 210 includes a SAR image storage unit 211. As described above, the SAR image storage unit 211 is a storage unit that stores the observed SAR image of the target region. The SAR image storage unit 211 stores an observed SAR image obtained by observing the target region in the steady state.

The SAR image storage unit 211 may further store observation conditions when the observed SAR image is observed, in association with the observed SAR image. The SAR image storage unit 211 may further store an observed SAR image obtained by observing the target region in a state other than the steady state (that is, there is a change from the steady state).

Information stored in the SAR image storage unit 211 may be generated by the information processing apparatus 210 or may be generated by an external device (not illustrated).

(Functional Configuration Example of Signal Processing Apparatus 200 according to Second Example Embodiment)

The signal processing apparatus 200 functionally includes a simulated SAR image generation unit 101 that is replaced with the simulated SAR image generation unit 101 according to the first example embodiment, an evaluation calculation unit 102, a change detection unit 103, a display unit 104, and a display control unit 105 that are similar to those in the first example embodiment, and a reconstruction unit 206.

The signal processing apparatus 200 may further include a SAR image storage unit 211. In this case, the signal processing system SPS does not need to include the information processing apparatus 210.

The simulated SAR image generation unit 101 generates simulation information by using the three-dimensional information with reliability generated by the reconstruction unit 206 and observation conditions in a case where an actual measured value is observed. As described above, the simulated SAR image generation unit 101 may be configured similarly to the simulated SAR image generation unit 101 according to the first example embodiment except that the three-dimensional information with reliability for generating the simulation information is acquired from the reconstruction unit 206.

The reconstruction unit 206 generates the above-described three-dimensional information with reliability by using the plurality of observed SAR images in the steady state. The reconstruction unit 206 may generate the above-described three-dimensional information with reliability by using one or a plurality of observed SAR images in a state other than the steady state in addition to the plurality of observed SAR images in the steady state.

The functional configuration example of the signal processing system SPS according to the second example embodiment has been described above. A physical configuration example of the signal processing system SPS according to the second example embodiment will be described below.

(Physical Configuration Example of Signal Processing System SPS according to Second Example Embodiment)

The signal processing system SPS according to the present example embodiment includes the signal processing apparatus 200 and the information processing apparatus 210 that are physically connected via the network NT. Each of the signal processing apparatus 200 and the information processing apparatus 210 includes a single physically different device. Each of the signal processing apparatus 200 and the information processing apparatus 210 may be physically configured similarly to the signal processing apparatus 100 according to the first example embodiment.

The signal processing apparatus 200 and the information processing apparatus 210 may be physically configured by a single device. In this case, the signal processing apparatus 200 and the information processing apparatus 210 may be connected by using an internal bus 1010 instead of the network NT. One or both of the signal processing apparatus 200 and the information processing apparatus 210 may physically include a plurality of apparatuses connected via an appropriate communication line such as the network NT.

The configuration example of the signal processing system SPS according to the second example embodiment has been described above. An operation example of the signal processing system SPS according to the second example embodiment will be described below.

(Operation Example of Signal Processing System SPS according to Second Example Embodiment)

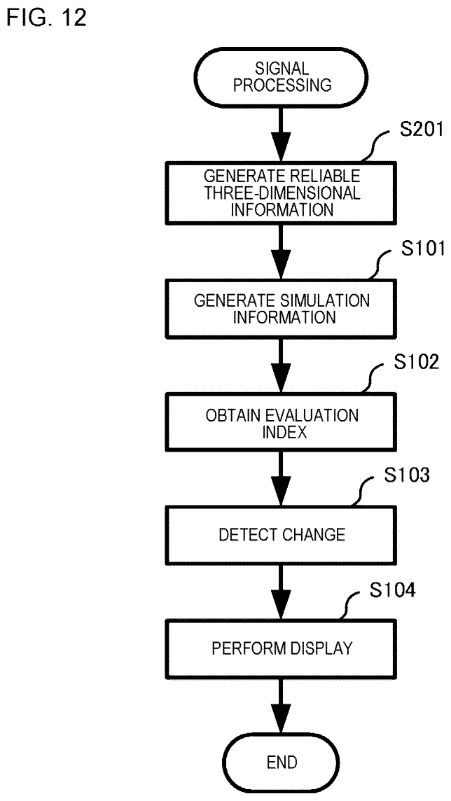

FIG. 12 is a flowchart illustrating an example of signal processing according to the second example embodiment. The signal processing according to the present example embodiment includes a three-dimensional information generation process (Step S201) in addition to the processes included in the signal processing according to the first example embodiment.

### (Step S201: Example of Three-Dimensional Information Generation Process)

The reconstruction unit 206 generates the three-dimensional information with reliability including three-dimensional information and estimation reliability information, by using the plurality of observed SAR images (Step S201).

Specifically, for example, the reconstruction unit 206 acquires a plurality of combinations of the observed SAR image in the steady state stored in the SAR image storage unit 211 and the observation conditions associated with the observed SAR image. The reconstruction unit 206 may acquire one or more combinations of an observed SAR image in a state other than the steady state and an observation condition associated with the observed SAR image.

The reconstruction unit 206 generates the three-dimensional information with reliability by using the acquired observed SAR image and observation conditions.

As described above, the three-dimensional information with reliability includes three-dimensional information and estimation reliability information indicating reliability of the three-dimensional information. The three-dimensional information includes a three-dimensional image. The three-dimensional image includes a voxel value related to each of a plurality of voxels constituting the three-dimensional image. The voxel value is, for example, a complex number value including the reflection intensity and the phase. For example, the voxel value may be a three-dimensional complex reflectivity distribution.

The three-dimensional information may further include the temperature, the displacement, and the like. The three-dimensional image may be three-dimensional point cloud data including information including the reflection intensity and the phase of each point.

### (Example of Three-Dimensional Image Generation Method)

One technique for generating three-dimensional images is SAR tomography. SAR tomography is a method of estimating a complex reflectivity distribution in an elevation direction for each pixel by using a plurality of observed SAR images. A general technique may be used as a technique for generating a three-dimensional image, and is not limited to the SAR tomography described herein.

The elevation direction is, for example, a direction perpendicular to an azimuth-range plane (a plane formed by a line-of-sight direction and a traveling direction of a flying object on which the SAR is mounted). That is, the three-dimensional image includes a plurality of voxel values in a three-dimensional space having an azimuth direction, a range direction, and an elevation direction. Each voxel value includes the reflection intensity (an estimated value of the reflection intensity) and the phase (an estimated value of the phase).

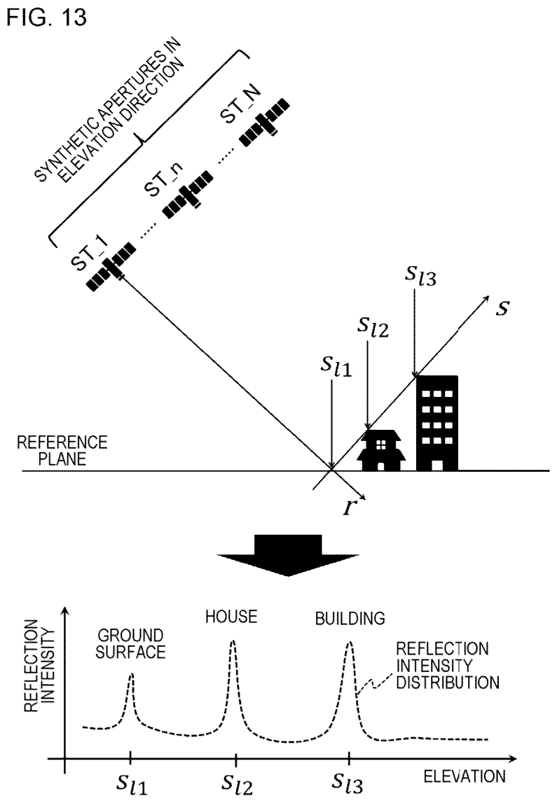

FIG. 13 is a diagram for describing an example of estimating the complex reflectivity distribution of a voxel at an azimuth-range position x by using SAR tomography. Here, x is a vector amount, and the same applies to the following.

In the drawing, s represents an elevation direction. A plane perpendicular to the direction s is an azimuth-range plane. The azimuth-range position x is an intersection point of an axis indicating the elevation direction in FIG. 13 and an axis indicating the line-of-sight direction of a satellite ST that is a flying object. Satellites ST_1, . . . , ST_n, and ST_N in the drawing indicate the satellite ST at different time points. N is an integer more than 1. n is an integer of 1 or more and N or less.

By using a plurality of observed SAR images, the reconstruction unit 206 estimates, for each pixel, a complex reflectivity distribution indicating the height, the reflection intensity, and the phase of a building that constantly exists for an observation period. The reconstruction unit 206 generates a three-dimensional image including a three-dimensional complex reflectivity distribution in a target region by combining the complex reflection intensities obtained for each pixel.

The reconstruction unit 206 uses a plurality of observed SAR images based on observations from slightly different trajectories in order to generate a three-dimensional image of a three-dimensional steady state. Therefore, the reconstruction unit 206 acquires a plurality of observed SAR images.

The upper part of FIG. 13 illustrates the first to N-th observations by SAR satellites. N corresponds to the total number of observations. The first to N-th observations illustrated in FIG. 13 correspond to synthetic apertures in the elevation direction. In the n-th observation, a relational formula between a received signal (complex signal) recorded in the pixel corresponding to the azimuth-range position x and the complex reflectivity distribution in this pixel is represented by, for example, the following Formula (1).

$$\begin{matrix}[ Math . 1 ] & \\ {g}_{obs} ( x , n ) = r ( x , n ) \cdot α ( x , n ) & Formula ( 1 )\end{matrix}$$

g_{obs}(x, n) in Formula (1) represents the received signal (complex signal) recorded in the pixel corresponding to the azimuth-range position x. In Formula (1), r(x, n) represents a steering vector in the pixel corresponding to the azimuth-range position x. In Formula (1), a(x, n) is a vector representing the complex reflectivity distribution in the pixel corresponding to the azimuth-range position x.

The steering vector r(x, n) can be obtained from an image capturing condition, for example, and is represented by the following Formula (2).

$$\begin{matrix}[ Math . 2 ] & \\ r ( x , n ) = [ exp ( - 4 j π {k}_{n} {s}_{1} ) , … , exp ( - 4 j π {k}_{n} {s}_{L} ) ] ∈ {ℂ}^{1 \times L} & Formula ( 2 )\end{matrix}$$

In Formula (2), kₙ represents an high-to-phase conversion factor (a coefficient for conversion between the phase and the altitude). sₗ(1=1, . . . , L) represents a position in the elevation direction.

The steering vector may be expressed by a formula other than Formula (2). For example, a steering vector in consideration of the influence of the temperature or the displacement may be used. j is an imaginary unit. π is a circular constant. Exp represents an exponential function with the Napier's constant as a base. C represents a complex number.

The reconstruction unit 206 solves the optimization problem by using Formulas (1) and (2) determined based on the first to N-th observation values, thereby obtaining the complex reflectivity distribution α of a building that constantly exists in the pixel corresponding to the azimuth-range position x.

In other words, the reconstruction unit 206 obtains the complex reflectivity distribution a of the building by determining the complex reflectivity distribution in such a way that the N times of observation data obtained by capturing an image of the target region including the building and the like match the N times of steering vectors.

The lower part of FIG. 13 illustrates an example of the absolute value |αbg| of the complex reflectivity distribution α of the building obtained by the reconstruction unit 206. The buildings constantly exist in the pixels corresponding to the azimuth-range positions x. The vertical axis of the graph illustrated in the lower part of FIG. 13 is the reflection intensity and corresponds to the absolute value |αbg|. The horizontal axis of the graph indicates an elevation position.

The complex reflectivity distribution α illustrated in FIG. 13 has large values at elevation positions sl1 (ground), sl2 (house), and sl3 (building). That is, a received signal at the position x is a signal in which the complex reflection intensities at the elevation positions sl1, sl2, and sl3 overlap with each other. More precisely, the received signal at the position x corresponds to the result of a Fourier transform of the complex reflectivity distribution in the elevation direction.

In the case of using SAR tomography, a three-dimensional image including a three-dimensional complex reflectivity distribution in the target region can be generated by combining the complex reflection intensities obtained for the respective pixels in this manner.

(Detailed Example of Three-Dimensional Information with Reliability)

The reconstruction unit 206 generates the three-dimensional information with reliability by using SAR tomography or the like. The three-dimensional information with reliability may be either first three-dimensional information with reliability or second three-dimensional information with reliability exemplified below. The three-dimensional information with reliability is not limited to this.

(Regarding First Three-Dimensional Information with Reliability)

The first three-dimensional information with reliability includes three-dimensional information including estimated values of the reflection intensity and the phase at each azimuth range elevation position, and estimation reliability information including an index value indicating reliability of each estimated value. The first three-dimensional information with reliability may further include at least one or more of the temperature, the displacement, and the like.

(1) For example, the reconstruction unit 206 may obtain the estimation reliability information by evaluating a difference between the received signal and a prediction signal predicted from the three-dimensional information for each of the reflection intensity and the phase.

There are various methods for evaluating the difference.

For example, the difference between the received signal and the prediction signal may be evaluated by using the difference between the received signal and the prediction signal (for example, a difference squared error, an absolute value difference, or the like). In this case, the estimation reliability information may include a difference between the received signal and the prediction signal.

For example, the difference between the received signal and the prediction signal may be evaluated using a function obtained by adding a term expressing complexity of the reconstructed three-dimensional information to the difference between the received signal and the prediction signal. In this case, the estimation reliability information may include a value (for example, the value of a loss function in LASSO regression, Ridge regression, or the like) using a function obtained by adding a term expressing the complexity of the reconstructed three-dimensional information to the difference between the received signal and the prediction signal.

As an example of the loss function, the following Formula (3) can be exemplified.

$$‖ {g}_{obs} ( x , n ) - r ( x , n ) \cdot α ( x ) ‖ {2}^{2} + λ {‖ α ( x ) ‖}_{p} \qquad Formula ( 3 )$$

In Formula (3), ∥·∥p represents the Lₚ norm, and λ represents a regularization constant. In Formula (3), the case of p=1 is an example of the loss function in the LASSO regression. In Formula (3), the case of p=2 is an example of the loss function in the Ridge regression. The loss function is not limited to this.

For example, the difference between the received signal and the prediction signal may be evaluated by using cross verification. The cross verification is a method of evaluating generalization performance of the reconstructed three-dimensional information by setting a received signal used to evaluate a difference from the prediction value to a received signal different from the received signal used to generate the three-dimensional information. In this case, the estimation reliability information may include a value indicating generalization performance of the reconstructed three-dimensional information by setting the received signal used to evaluate the difference from the prediction value to the received signal different from the received signal used to generate the three-dimensional information.

Specifically, for example, the received signal different from the received signal used to generate the three-dimensional information is a received signal not used to reconstruct the three-dimensional information. In this case, the value obtained by the cross verification is, for example, a value obtained by evaluating the difference between the prediction signal and the received signal with respect to the received signal that is not used to reconstruct the three-dimensional information.

More specifically, for example, the reconstruction unit 206 reconstructs the three-dimensional information by using the received signal (observation value) obtained in (N−1) times of observations excluding the m-th observation among the first to N-th observations. In this case, the reconstruction unit 206 may obtain a value for evaluating the reliability using the following Formula (4) and generate the estimation reliability information including this value. The cross verification method is not limited to this.

$${‖ {g}_{obs} ( x , m ) - r ( x , m ) \cdot α ( x ) ‖}_{2}^{2} \qquad Formula ( 4 )$$

In Formula (4), ∥·∥₂ represents the L₂ norm. g_{obs}(x, m) represents a received signal obtained in the m-th observation, that is, a received signal that is not used to reconstruct the three-dimensional information. r(x, m)·α(x) represents a prediction signal predicted based on three-dimensional information reconstructed from (N−1) times of observations excluding the m-th observation value.

(2) For example, the reconstruction unit 206 may obtain the estimation reliability information by evaluating how likely each estimated value in the three-dimensional information is among possible values. This evaluation may be represented using, for example, a parameter (variance, confidence interval, or the like) of a posterior distribution of each estimated value obtained by Bayesian estimation, a shape of the posterior distribution, and the like. In this case, the estimation reliability information may include a value indicating how likely each estimated value in the three-dimensional information is among possible values.

(Regarding Second Three-Dimensional Information with Reliability)

The second three-dimensional information with reliability may include a function representing a relationship between the reflection intensity and the phase for each three-dimensional element and each likelihood. That is, the reconstruction unit 206 may obtain, as the three-dimensional information with reliability, a function representing the relationship between the reflection intensity and the phase for each three-dimensional element and each likelihood.

The function representing the relationship between the reflection intensity and the phase and each likelihood may include, for example, at least one of a posterior distribution, a statistical index of the posterior distribution, and a candidate group of post-sampled three-dimensional information (estimated values of the reflection intensity and the phase). The statistical index may be at least one of an average value, a mode value, a variance, a standard deviation, and a confidence interval.

(Step S101 according to Second Example Embodiment: Example of Simulation Information Generation Process)

Reference is made again to FIG. 12.

The simulated SAR image generation unit 101 generates simulation information (Step S101).

In Step S101 according to the present example embodiment, the simulated SAR image generation unit 101 generates simulation information by using the three-dimensional information with reliability generated in Step S201. For example, the simulated SAR image generation unit 101 obtains a steering vector from measurement conditions of the target SAR image and generates the simulation information from the three-dimensional information with reliability

Specifically, for example, in a case where the first three-dimensional information with reliability is generated in Step S201, the simulated SAR image generation unit 101 may obtain the prediction reliability information by statistical processing using the simulated SAR image and the estimation reliability information.

In a case where the second three-dimensional information with reliability is generated in Step S201, the simulated SAR image generation unit 101 may estimate a plurality of simulated complex signal candidates estimated from the three-dimensional information with reliability and the likelihood of each of the plurality of simulated complex signal candidates.

The simulated SAR image generation unit 101 may then select or generate a likely simulated complex signal as the reliability information. For example, it is assumed that the function representing the relationship between the reflection intensity and the phase for each three-dimensional element and each likelihood is input to the simulated SAR image generation unit 101. The likely simulated complex signal in this case is, for example, a simulated complex signal having the highest probability in a case where the prediction signal in the simulated SAR image is estimated under the condition of the input function.

Steps S102 to S104 may be similar to those described in the first example embodiment.

By performing this signal processing, it is possible to generate three-dimensional information with reliability by using a plurality of observed SAR images. The simulation information can be generated using the three-dimensional information with reliability, and the evaluation index of the target SAR image can be obtained using the simulation information.

### (Operations and Effects)

As described above, according to the present example embodiment, the signal processing apparatus 200 includes the reconstruction unit 206.

The reconstruction unit 206 generates the three-dimensional information with reliability including three-dimensional information and estimation reliability information, by using the plurality of observed SAR images. The three-dimensional information includes an estimated value of each of the reflection intensity and the phase for each of three-dimensional elements constituting the target region. The estimation reliability information indicates the reliability of the estimated value of each three-dimensional element.

The simulated SAR image generation unit 101 generates simulation information by using three-dimensional information with reliability and observation conditions in a case where an actual measured value is observed (target SAR image). The number of target SAR images may be one or plural. The target SAR image may include, for example, one or a plurality of SAR images that are appropriately designated from among the observed SAR images stored in the SAR image storage unit 211, or may include a new observed SAR image that is not stored in the SAR image storage unit 211.

As a result, it is possible to generate the three-dimensional information with reliability by using a plurality of observed SAR images. The simulation information can be generated using the three-dimensional information with reliability, and the evaluation index of the target SAR image can be obtained using the simulation information. Therefore, the target SAR image can be evaluated in consideration of the reliability of the simulated SAR image. Thus, it is possible to detect a change in the target region by using the SAR image with high accuracy.

According to the present example embodiment, the reconstruction unit 206 obtains the estimation reliability information by evaluating the difference between the received signal and the prediction signal predicted from the three-dimensional information for each of the reflection intensity and the phase.

As a result, it is possible to generate the three-dimensional information with reliability by using a plurality of observed SAR images. Therefore, as described above, the target SAR image can be evaluated in consideration of the reliability of the simulated SAR image. Thus, it is possible to detect a change in the target region by using the SAR image with high accuracy.

According to the present example embodiment, the reconstruction unit 206 obtains the estimation reliability information by evaluating how likely each estimated value in the three-dimensional information is among possible values.

As a result, it is possible to generate the three-dimensional information with reliability by using a plurality of observed SAR images. Therefore, as described above, the target SAR image can be evaluated in consideration of the reliability of the simulated SAR image. Thus, it is possible to detect a change in the target region by using the SAR image with high accuracy.

According to the present example embodiment, the simulated SAR image generation unit 101 obtains the prediction reliability information by statistical processing using the simulated SAR image and the estimation reliability information.

As a result, it is possible to generate the simulation information including the prediction reliability information by using the three-dimensional information with reliability, and obtain an evaluation index of the target SAR image by using the simulation information. Therefore, the target SAR image can be evaluated in consideration of the reliability of the simulated SAR image. Thus, it is possible to detect a change in the target region by using the SAR image with high accuracy.

According to the present example embodiment, the reconstruction unit 206 obtains, as the three-dimensional information with reliability, the function representing the relationship between the reflection intensity and the phase for each three-dimensional element and each likelihood.

As a result, it is possible to generate the three-dimensional information with reliability by using a plurality of observed SAR images. Therefore, as described above, the target SAR image can be evaluated in consideration of the reliability of the simulated SAR image. Thus, it is possible to detect a change in the target region by using the SAR image with high accuracy.

According to the present example embodiment, the simulated SAR image generation unit 101 estimates a plurality of simulated complex signal candidates estimated from the three-dimensional information with reliability and the likelihood of each of the plurality of simulated complex signal candidates, and selects or generates a likely simulated complex signal as the reliability information.

As a result, it is possible to generate the simulation information including the prediction reliability information by using the three-dimensional information with reliability, and obtain an evaluation index of the target SAR image by using the simulation information. Therefore, the target SAR image can be evaluated in consideration of the reliability of the simulated SAR image. Thus, it is possible to detect a change in the target region by using the SAR image with high accuracy.

### Third Example Embodiment

In the present example embodiment, an example in which the evaluation index is a posterior probability that an observation value is observed for each corresponding pixel in the simulated SAR image and the target SAR image will be described.

In the present example embodiment, in order to simplify the description, the description overlapping with the first example embodiment will be appropriately omitted.

An evaluation calculation unit 102 (see, for example, FIG. 3) according to the present example embodiment obtains an evaluation index for each corresponding pixel by using the simulation information and the target SAR image. Each evaluation index is a posterior probability that an observation value is observed for each corresponding pixel in the simulated SAR image and the target SAR image.

(Step S102 according to Third Example Embodiment: Example of Evaluation Index Acquisition Process)

In Step S102 (see, for example, FIG. 7) according to the third example embodiment, the evaluation calculation unit 102 obtains an evaluation index (posterior probability) for each corresponding pixel by using the simulation information and the target SAR image (Step S102).

Specifically, for example, in a case where the simulation information includes a prediction distribution, the evaluation calculation unit 102 may obtain, as the posterior probability, a conditional probability that an observation value included in the target SAR image is observed under a measurement condition related to the prediction distribution.

For example, in a case where the simulation information includes the simulated SAR image and the statistical index (prediction reliability information) of the prediction distribution, the evaluation calculation unit 102 may obtain, as the posterior probability, a value obtained by normalizing a distance between the observation value and the prediction value on the complex plane with the standard deviation of the prediction distribution. The observation value corresponds to a pixel value in each pixel of the target SAR image. The prediction value corresponds to a pixel value in each pixel of the simulated SAR image. At this time, the prediction distribution may be assumed to be a circular symmetric complex normal distribution.

The method of obtaining the posterior probability is not limited to this. Although the present example embodiment has been described with reference to FIGS. 3 and 7, the evaluation calculation unit 102 and the evaluation index acquisition process (Step S102) according to the present example embodiment may be applied to, for example, the second example embodiment.

### (Operations and Effects)

As described above, according to the present example embodiment, each of the evaluation indices is the posterior probability that the observation value is observed for each corresponding pixel in the simulated SAR image and the target SAR image. The evaluation calculation unit 102 obtains the evaluation index for each corresponding pixel by using the simulation information and the target SAR image.

As a result, it is possible to obtain the posterior probability as the evaluation index of the target SAR image by using the simulated SAR image and the prediction reliability information. Therefore, the target SAR image can be evaluated in consideration of the reliability of the simulated SAR image. Thus, it is possible to detect a change in the target region by using the SAR image with high accuracy.

### Fourth Example Embodiment

In the present example embodiment, an example in which the evaluation index is a simultaneous probability that an observation value is observed for each corresponding pixel in the simulated SAR image and a plurality of target SAR images will be described. In the present example embodiment, there are a plurality of target SAR images.

In the present example embodiment, in order to simplify the description, the description overlapping with the first example embodiment will be appropriately omitted.

The evaluation calculation unit 102 (see, for example, FIG. 3) according to the present example embodiment obtains a plurality of evaluation indices. Each of the plurality of evaluation indices is a simultaneous probability that an observation value is observed for each corresponding pixel in the simulated SAR image and a plurality of target SAR images.

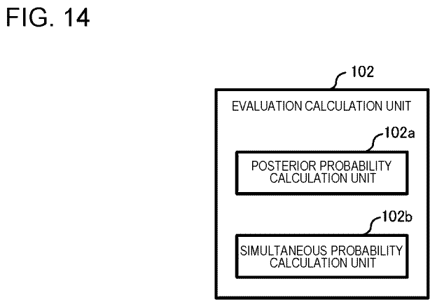

FIG. 14 is a diagram illustrating a functional configuration example of an evaluation calculation unit 102 according to a fourth example embodiment. The evaluation calculation unit 102 according to the present example embodiment includes a posterior probability calculation unit 102a and a simultaneous probability calculation unit 102b.

The posterior probability calculation unit 102a obtains a posterior probability that an observation value is observed for each corresponding pixel, by using the simulation information and each of the plurality of target SAR images.

The simultaneous probability calculation unit 102b obtains an evaluation index for each corresponding pixel by combining the posterior probabilities obtained using each of the plurality of target SAR images for each corresponding pixel.

(Step S102 according to Fourth Example Embodiment: Example of Evaluation Index Acquisition Process)

In Step S102 (see, for example, FIG. 7) according to the fourth example embodiment, the evaluation calculation unit 102 obtains, as the evaluation index, a simultaneous probability that an observation value is observed for each corresponding pixel in the simulated SAR image and the plurality of target SAR images (Step S102).

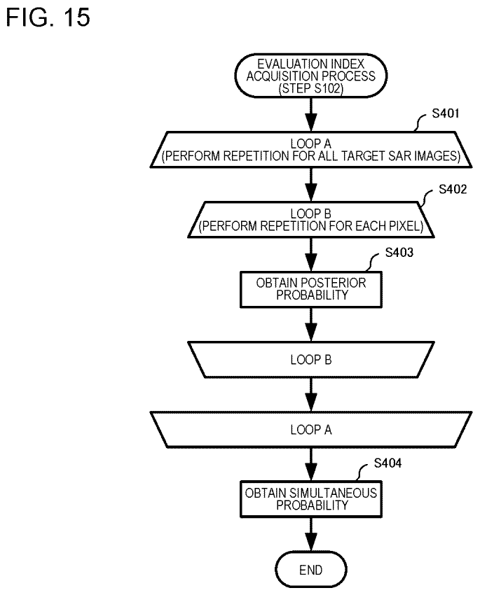

FIG. 15 is a flowchart illustrating a detailed example of an evaluation index acquisition process (Step S102) according to the fourth example embodiment.

The posterior probability calculation unit 102a repeats Steps S402 and S403 for each of all the target SAR images (Step S401; Loop A). The posterior probability calculation unit 102a repeats Step S403 for each corresponding pixel in the target SAR image and the simulated SAR image that are processing targets (Step S402; Loop B).

By using the simulation information and the target SAR image that is a processing target in Loop A, the posterior probability calculation unit 102a obtains, for a pixel that is a processing target in Loop B, a posterior probability that an observation value related to the pixel is observed (Step S403).

This observation value corresponds to a pixel value included in the target SAR image that is a processing target. As the method of obtaining the posterior probability in Step S403, for example, any one of the methods used in Step S102 in the third example embodiment may be used. The method of obtaining the posterior probability is not limited to the method described in the third example embodiment.

By executing Steps S401 to S403, the posterior probability calculation unit 102a can obtain the posterior probability that the observation value is observed for each corresponding pixel by using the simulation information and each of the plurality of target SAR images. The simultaneous probability calculation unit 102b combines the posterior probabilities obtained using each of the plurality of target SAR images for each corresponding pixel. As a result, the simultaneous probability calculation unit 102b obtains, as the evaluation index, a simultaneous probability for each corresponding pixel in the plurality of target SAR images (Step S404).

This simultaneous probability is a probability that observation values for each corresponding pixel in a plurality of target SAR images are simultaneously obtained under a condition that a simulated SAR image of a target region is obtained.

Although the present example embodiment has been described with reference to FIGS. 3 and 7, the evaluation calculation unit 102 and the evaluation index acquisition process (Step S102) according to the present example embodiment may be applied to, for example, the second example embodiment.

### (Operations and Effects)

As described above, according to the present example embodiment, each of the evaluation indices is the simultaneous probability that the observation value is observed for each corresponding pixel in the simulated SAR image and a plurality of target SAR images.

The evaluation calculation unit 102 includes the posterior probability calculation unit 102a and the simultaneous probability calculation unit 102b. The posterior probability calculation unit 102a obtains a posterior probability that an observation value is observed for each corresponding pixel, by using the simulation information and each of the plurality of target SAR images. The simultaneous probability calculation unit 102b obtains an evaluation index for each corresponding pixel by combining the posterior probabilities obtained using each of the plurality of target SAR images for each corresponding pixel.

As a result, it is possible to obtain the simultaneous probability as the evaluation index of a plurality of target SAR images by using the simulated SAR image and the prediction reliability information. Therefore, it is possible to evaluate a plurality of target SAR images with higher accuracy in consideration of the reliability of the simulated SAR image. Thus, it is possible to detect a change in the target region by using the SAR image with high accuracy.

### Fifth Example Embodiment

In the present example embodiment, an example in which the evaluation index is a simultaneous probability that an observation value is observed for each corresponding pixel group in the simulated SAR image and the target SAR image will be described.

In the present example embodiment, in order to simplify the description, the description overlapping with the first example embodiment will be appropriately omitted.

The evaluation calculation unit 102 (see, for example, FIG. 3) according to the present example embodiment obtains a plurality of evaluation indices. Each of the plurality of evaluation indices is a simultaneous probability that an observation value is observed for each corresponding pixel group in the simulated SAR image and the target SAR image.

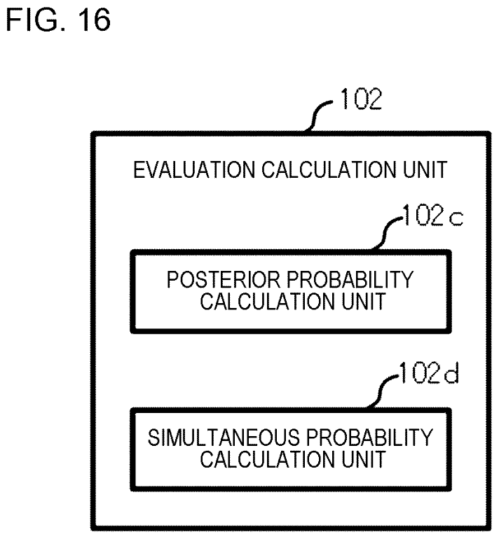

FIG. 16 is a diagram illustrating a functional configuration example of an evaluation calculation unit 102 according to a fifth example embodiment. The evaluation calculation unit 102 according to the present example embodiment includes a posterior probability calculation unit 102c and a simultaneous probability calculation unit 102d.

Using the simulation information and the target SAR image, the posterior probability calculation unit 102c obtains a posterior probability that an observation value is observed for each corresponding pixel in the simulated SAR image and the target SAR image.

The simultaneous probability calculation unit 102d obtains an evaluation index for each corresponding pixel group by combining the posterior probabilities obtained for the respective pixels constituting the pixel group for each corresponding pixel group in the simulated SAR image and the target SAR image.

The corresponding pixel group in the simulated SAR image and the target SAR image may include, for example, a plurality of pixels within one or a plurality of predetermined ranges. The plurality of predetermined ranges may be determined in such a way to include, for example, the entirety of the simulated SAR image and the target SAR image without overlapping with each other.

The plurality of predetermined ranges may partially overlap with each other, or may not all overlap with each other. The one or plurality of predetermined ranges may be determined for corresponding partial regions in the simulated SAR image and the target SAR image.

(Step S102 according to Fifth Example Embodiment: Example of Evaluation Index Acquisition Process)

In Step S102 (see, for example, FIG. 7) according to the fifth example embodiment, the evaluation calculation unit 102 obtains, as the evaluation index, a simultaneous probability that an observation value is observed for each corresponding pixel group in the simulated SAR image and the target SAR image (Step S102).

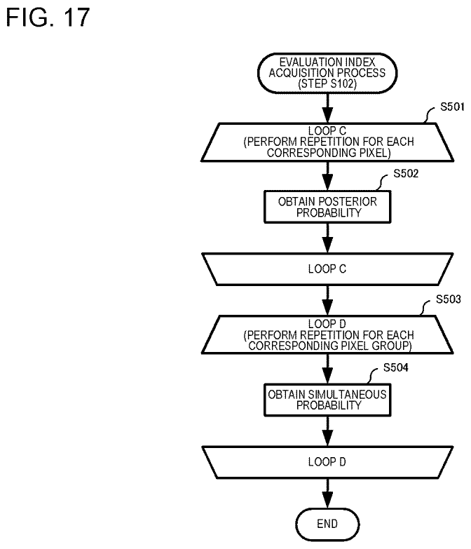

FIG. 17 is a flowchart illustrating a detailed example of an evaluation index acquisition process (Step S102) according to the fifth example embodiment.

The posterior probability calculation unit 102c repeats Step S502 for each corresponding pixel in the simulated SAR image and the target SAR image included in the simulation information (Step S501; Loop C).

By using the simulation information and the target SAR image, the posterior probability calculation unit 102c obtains, for a pixel that is a processing target in Loop C, a posterior probability that an observation value related to the pixel is observed (Step S502).

This observation value corresponds to a pixel value included in the target SAR image. As the method of obtaining the posterior probability in Step S502, for example, any one of the methods used in Step S102 in the third example embodiment may be used. The method of obtaining the posterior probability is not limited to the method described in the third example embodiment.

By executing Steps S501 to S502, the posterior probability calculation unit 102c can obtain the posterior probability that the observation value is observed for each corresponding pixel in the simulated SAR image and the target SAR image by using the simulation information and the target SAR image.

The simultaneous probability calculation unit 102d repeats Step S504 for each corresponding pixel group in the simulated SAR image and the target SAR image (Step S503; Loop D).

The simultaneous probability calculation unit 102d combines the posterior probabilities obtained in Step S502 for each pixel constituting the pixel group that is a processing target. As a result, the simultaneous probability calculation unit 102d obtains the evaluation index of the pixel group that is the processing target (Step S504).

By executing Steps S501 to S502, the simultaneous probability calculation unit 102d can obtain the simultaneous probability that the observation value is observed for each corresponding pixel group in the simulated SAR image and the target SAR image.

This simultaneous probability is a probability that observation values of a pixel group included in the target SAR image are simultaneously obtained under a condition that a simulated SAR image of a target region is obtained.

Although the present example embodiment has been described with reference to FIGS. 3 and 7, the evaluation calculation unit 102 and the evaluation index acquisition process (Step S102) according to the present example embodiment may be applied to, for example, the second example embodiment.

### (Operations and Effects)

As described above, according to the present example embodiment, each of the evaluation indices is the simultaneous probability that the observation value is observed for each corresponding pixel group in the simulated SAR image and the target SAR image.

The evaluation calculation unit 102 includes the posterior probability calculation unit 102c and the simultaneous probability calculation unit 102d. The posterior probability calculation unit 102c obtains the posterior probability that the observation value is obtained for each corresponding pixel by using the simulation information and the target SAR image. The simultaneous probability calculation unit 102d obtains an evaluation index for each corresponding pixel group by combining the posterior probabilities obtained for the respective pixels constituting the pixel group for each corresponding pixel group.

As a result, it is possible to obtain the simultaneous probability as the evaluation index of a pixel group included in the target SAR image by using the simulated SAR image and the prediction reliability information. Therefore, it is possible to evaluate a plurality of target SAR images with higher accuracy in consideration of the reliability of the simulated SAR image. Thus, it is possible to detect a change in the target region by using the SAR image with high accuracy.

While the example embodiments and modification examples of the present invention have been described above with reference to the drawings, these are examples of the present invention, and various configurations other than the above description can be adopted.

In addition, in the plurality of flowcharts used in the above description, a plurality of steps (processing) is described in order, but the execution order of the steps executed in each example embodiment is not limited to the described order. In each example embodiment, the order of the illustrated steps can be changed as long as there is no problem in terms of content. The above-described example embodiments and the modification examples can be combined within a range in which the contents are not contradictory.

Some or all of the above example embodiments may be described as the following Supplementary Notes, but are not limited to the following.

1. A signal processing apparatus including:
simulated SAR image generation means for generating simulation information including a simulated SAR image including a prediction value of each pixel predicted to be obtained in a case where a target region in a steady state is observed, and prediction reliability information indicating reliability of the prediction value of each pixel; and
evaluation calculation means for obtaining an evaluation index obtained by evaluating a target SAR image that is an analysis target, by using the simulation information.

2. The signal processing apparatus described in 1, in which
each of the simulated SAR image and the target SAR image is a two-dimensional complex image.

3. The signal processing apparatus described in 1 or 2, in which
the prediction value of each pixel is a complex number value including a reflection intensity component and a phase component predicted to be obtained in a case where the target region in the steady state is observed under the same observation conditions as those of the target SAR image.

4. The signal processing apparatus described in any of 1 to 3, in which
the prediction reliability information includes at least one of a prediction distribution indicating a probabilistic distribution of the prediction value, a statistical index of the prediction distribution, and a probability of being the prediction value.

5. The signal processing apparatus described in any one of 1 to 4, in which
the target SAR image includes observation values of pixels obtained by actually observing the target region,
a plurality of the evaluation indices are provided, and
the evaluation index is an index obtained by stochastically evaluating a degree to which the observation value constituting the target SAR image does not contradict the prediction value constituting the simulated SAR image.

6. The signal processing apparatus described in 5, in which
each of the evaluation indices is a posterior probability that the observation value is observed for each corresponding pixel in the simulated SAR image and the target SAR image, and
the evaluation calculation means obtains the evaluation index for each corresponding pixel by using the simulation information and the target SAR image.

7. The signal processing apparatus described in 5, in which
each of the evaluation indices is a simultaneous probability that the observation value is observed for each corresponding pixel in the simulated SAR image and a plurality of target SAR images, and
the evaluation calculation means includes
posterior probability calculation means for obtaining a posterior probability that the observation value is observed for each corresponding pixel by using the simulation information and each of the plurality of target SAR images, and
simultaneous probability calculation means for obtaining the evaluation index for each corresponding pixel by combining posterior probabilities obtained by using each of the plurality of target SAR images for each corresponding pixel.

8. The signal processing apparatus described in 5, in which
each of the evaluation indices is a simultaneous probability that the observation value is observed for each corresponding pixel group in the simulated SAR image and the target SAR image, and
the evaluation calculation means includes
posterior probability calculation means for obtaining a posterior probability that the observation value is obtained for each corresponding pixel by using the simulation information and the target SAR image, and
simultaneous probability calculation means for obtaining the evaluation index for each corresponding pixel group by combining posterior probabilities obtained for each of pixels constituting the pixel group for each corresponding pixel group.

9. The signal processing apparatus described in any one of 1 to 8, further including
change detection means for detecting a change in the target region by using the evaluation index.

10. The signal processing apparatus described in any one of 1 to 9, further including:
reconstruction means for generating, by using a plurality of observed SAR images, three-dimensional information with reliability including three-dimensional information including an estimated value of each of a reflection intensity and a phase for each of three-dimensional elements constituting the target region, and estimation reliability information indicating reliability of the estimated value of each of the three-dimensional elements, in which
the simulated SAR image generation means generates the simulation information by using the three-dimensional information with reliability and an observation condition in a case where the actual measured value is observed.

11. The signal processing apparatus described in 10, in which
the reconstruction means obtains the estimation reliability information by evaluating a difference between a received signal and a prediction signal predicted from the three-dimensional information for each of the reflection intensity and the phase.

12. The signal processing apparatus described in 10, in which
the reconstruction means obtains the estimation reliability information by evaluating how likely each estimated value in the three-dimensional information is among possible values.

13. The signal processing apparatus described in 11 or 12, in which
the simulated SAR image generation means obtains the prediction reliability information by statistical processing using the simulated SAR image and the estimation reliability information.

14. The signal processing apparatus described in 10, in which
the reconstruction means obtains, as the three-dimensional information with reliability, a function representing a relationship between the reflection intensity and the phase for each three-dimensional element, and each likelihood.

15. The signal processing apparatus described in 14, in which
the simulated SAR image generation means estimates a plurality of simulated complex signal candidates estimated from the three-dimensional information with reliability and the likelihood of each of the plurality of simulated complex signal candidates, and selects or generates a likely simulated complex signal as the reliability information.

16. A signal processing system including:
simulated SAR image generation means for generating simulation information including a simulated SAR image including a prediction value of each pixel predicted to be obtained in a case where a target region in a steady state is observed, and prediction reliability information indicating reliability of the prediction value of each pixel;
evaluation calculation means for obtaining an evaluation index obtained by evaluating a target SAR image that is an analysis target, by using the simulation information;
SAR image storage means for storing the observed SAR image of the target region including observation values obtained by observing the target region using a synthetic aperture radar; and
reconstruction means for generating, by using a plurality of the observed SAR images, three-dimensional information with reliability including three-dimensional information including an estimated value of each of a reflection intensity and a phase for each of three-dimensional elements constituting the target region, and estimation reliability information indicating reliability of the estimated value of each three-dimensional element, in which
the simulated SAR image generation means generates the simulation information by using the three-dimensional information with reliability and an observation condition in a case where the actual measured value is observed.

17. A signal processing method including:
by one or more computers,
generating simulation information including a simulated SAR image formed from a prediction value of each pixel predicted to be obtained in a case where a target region in a steady state is observed, and prediction reliability information indicating reliability of the prediction value of each pixel; and
obtaining an evaluation index obtained by evaluating a target SAR image that is an analysis target, by using the simulation information.

18. The signal processing method described in 17, in which
each of the simulated SAR image and the target SAR image is a two-dimensional complex image.

19. The signal processing method described in 17 or 18, in which
the prediction value of each pixel is a complex number value including a reflection intensity component and a phase component predicted to be obtained in a case where the target region in the steady state is observed under the same observation conditions as those of the target SAR image.

20. The signal processing method described in any of 17 to 19, in which
the prediction reliability information includes at least one of a prediction distribution indicating a probabilistic distribution of the prediction value, a statistical index of the prediction distribution, and a probability of being the prediction value.

21. The signal processing method described in any one of 17 to 20, in which
the target SAR image includes observation values of pixels obtained by actually observing the target region,
a plurality of the evaluation indices are provided, and
the evaluation index is an index obtained by stochastically evaluating a degree to which the observation value constituting the target SAR image does not contradict the prediction value constituting the simulated SAR image.

22. The signal processing method described in 21, in which
each of the evaluation indices is a posterior probability that the observation value is observed for each corresponding pixel in the simulated SAR image and the target SAR image, and
the obtaining of the evaluation index includes obtaining the evaluation index for each corresponding pixel by using the simulation information and the target SAR image.

23. The signal processing method described in 21, in which
each of the evaluation indices is a simultaneous probability that the observation value is observed for each corresponding pixel in the simulated SAR image and a plurality of target SAR images, and
the obtaining of the evaluation index includes
obtaining a posterior probability that the observation value is observed for each corresponding pixel by using the simulation information and each of the plurality of target SAR images, and
obtaining the evaluation index for each corresponding pixel by combining posterior probabilities obtained by using each of the plurality of target SAR images for each corresponding pixel.

24. The signal processing method described in 21, in which
each of the evaluation indices is a simultaneous probability that the observation value is observed for each corresponding pixel group in the simulated SAR image and the target SAR image, and
the obtaining of the evaluation index includes
obtaining a posterior probability that the observation value is obtained for each corresponding pixel by using the simulation information and the target SAR image, and
obtaining the evaluation index for each corresponding pixel group by combining posterior probabilities obtained for each of pixels constituting the pixel group for each corresponding pixel group.

25. The signal processing method described in any one of 17 to 24, further including
detecting a change in the target region by using the evaluation index.

26. The signal processing method described in any one of 17 to 25, further including:
generating, by using a plurality of observed SAR images, three-dimensional information with reliability including three-dimensional information including an estimated value of each of a reflection intensity and a phase for each of three-dimensional elements constituting the target region, and estimation reliability information indicating reliability of the estimated value of each of the three-dimensional elements, in which
the generating of the simulation information includes generating the simulation information by using the three-dimensional information with reliability and an observation condition in a case where the actual measured value is observed.

27. The signal processing method described in 26, in which
the generating of the three-dimensional information with reliability includes obtaining the estimation reliability information by evaluating a difference between a received signal and a prediction signal predicted from the three-dimensional information for each of the reflection intensity and the phase.

28. The signal processing method described in 26, in which
the generating of the three-dimensional information with reliability includes obtaining the estimation reliability information by evaluating how likely each estimated value in the three-dimensional information is among possible values.

29. The signal processing method described in 27 or 28, in which
the generating of the simulation information includes obtaining the prediction reliability information by statistical processing using the simulated SAR image and the estimation reliability information.

30. The signal processing method described in 26, in which
the generating of the three-dimensional information with reliability includes obtaining, as the three-dimensional information with reliability, a function representing a relationship between the reflection intensity and the phase for each three-dimensional element, and each likelihood.

31. The signal processing method described in 30, in which
the generating of the simulation information includes estimating a plurality of simulated complex signal candidates estimated from the three-dimensional information with reliability and the likelihood of each of the plurality of simulated complex signal candidates, and selecting or generating a likely simulated complex signal as the reliability information.

32. A program for causing one or more computers to execute:
generating simulation information including a simulated SAR image formed from a prediction value of each pixel predicted to be obtained in a case where a target region in a steady state is observed, and prediction reliability information indicating reliability of the prediction value of each pixel; and
obtaining an evaluation index obtained by evaluating a target SAR image that is an analysis target, by using the simulation information.

33. The program described in 32, in which
each of the simulated SAR image and the target SAR image is a two-dimensional complex image.

34. The program described in 32 or 33, in which
the prediction value of each pixel is a complex number value including a reflection intensity component and a phase component predicted to be obtained in a case where the target region in the steady state is observed under the same observation conditions as those of the target SAR image.

35. The program described in any of 32 to 34, in which
the prediction reliability information includes at least one of a prediction distribution indicating a probabilistic distribution of the prediction value, a statistical index of the prediction distribution, and a probability of being the prediction value.

36. The program described in any one of 32 to 35, in which
the target SAR image includes observation values of pixels obtained by actually observing the target region,
a plurality of the evaluation indices are provided, and
the evaluation index is an index obtained by stochastically evaluating a degree to which the observation value constituting the target SAR image does not contradict the prediction value constituting the simulated SAR image.

37. The program described in 36, in which
each of the evaluation indices is a posterior probability that the observation value is observed for each corresponding pixel in the simulated SAR image and the target SAR image, and
the obtaining of the evaluation index includes obtaining the evaluation index for each corresponding pixel by using the simulation information and the target SAR image.

38. The program described in 36, in which
each of the evaluation indices is a simultaneous probability that the observation value is observed for each corresponding pixel in the simulated SAR image and a plurality of target SAR images, and
the obtaining of the evaluation index includes
obtaining a posterior probability that the observation value is observed for each corresponding pixel by using the simulation information and each of the plurality of target SAR images, and
obtaining the evaluation index for each corresponding pixel by combining posterior probabilities obtained by using each of the plurality of target SAR images for each corresponding pixel.

39. The program described in 36, in which
each of the evaluation indices is a simultaneous probability that the observation value is observed for each corresponding pixel group in the simulated SAR image and the target SAR image, and
the obtaining the evaluation index includes
obtaining a posterior probability that the observation value is obtained for each corresponding pixel by using the simulation information and the target SAR image, and
obtaining the evaluation index for each corresponding pixel group by combining posterior probabilities obtained for each of pixels constituting the pixel group for each corresponding pixel group.

40. The program described in any one of 32 to 39, in which
the program causes the one or more computers to further execute detecting a change in the target region by using the evaluation index.

41. The program described in any one of 32 to 40, in which
the program causes the one or more computers to further execute generating, by using a plurality of observed SAR images, three-dimensional information with reliability including three-dimensional information including an estimated value of each of a reflection intensity and a phase for each of three-dimensional elements constituting the target region, and estimation reliability information indicating reliability of the estimated value of each of the three-dimensional elements, and
the generating of the simulation information includes generating the simulation information by using the three-dimensional information with reliability and an observation condition in a case where the actual measured value is observed.

42. The program described in 41, in which
the generating of the three-dimensional information with reliability includes obtaining the estimation reliability information by evaluating a difference between a received signal and a prediction signal predicted from the three-dimensional information for each of the reflection intensity and the phase.

43. The program described in 41, in which
the generating of the three-dimensional information with reliability includes obtaining the estimation reliability information by evaluating how likely each estimated value in the three-dimensional information is among possible values.

44. The program described in 42 or 43, in which
the generating of the simulation information includes obtaining the prediction reliability information by statistical processing using the simulated SAR image and the estimation reliability information.

45. The program described in 41, in which
the generating of the three-dimensional information with reliability includes obtaining, as the three-dimensional information with reliability, a function representing a relationship between the reflection intensity and the phase for each three-dimensional element, and each likelihood.

46. The program described in 45, in which
the generating of the simulation information includes estimating a plurality of simulated complex signal candidates estimated from the three-dimensional information with reliability and the likelihood of each of the plurality of simulated complex signal candidates, and selecting or generating a likely simulated complex signal as the reliability information.

47. A recording medium recording the program described in any one of 32 to 46.

This application is based upon and claims the benefit of priority from Japanese patent application No. 2023-001674, filed on Jan. 10, 2023, the disclosure of which is incorporated herein in its entirety by reference.

### REFERENCE SIGNS LIST

100, 200 signal processing apparatus
101 simulated SAR image generation unit
102 evaluation calculation unit
102a, 102c posterior probability calculation unit
102b, 102d simultaneous probability calculation unit
103 change detection unit
104 display unit
105 display control unit
206 reconstruction unit
210 information processing apparatus
211 SAR image storage unit

What is claimed is:

1. A signal processing apparatus comprising:
a memory configured to store instructions; and
a processor configured to execute the instructions to:
generate simulation information including a simulated SAR image including a prediction value of each pixel predicted to be obtained in a case where a target region in a steady state is observed, and prediction reliability information indicating reliability of the prediction value of each pixel; and
obtain an evaluation index obtained by evaluating a target SAR image that is an analysis target, by using the simulation information.

2. The signal processing apparatus according to claim 1, wherein
the prediction value of each pixel is a complex number value including a reflection intensity component and a phase component predicted to be obtained in a case where the target region in the steady state is observed under the same observation condition as an observation condition of the target SAR image, and
the prediction reliability information includes at least one of a prediction distribution indicating a probabilistic distribution of the prediction value, a statistical index of the prediction distribution, and a probability of being the prediction value.

3. The signal processing apparatus according to claim 1, wherein
the target SAR image includes observation values of pixels obtained by actually observing the target region,
a plurality of the evaluation indices are provided, and
the evaluation index is an index obtained by stochastically evaluating a degree to which the observation value constituting the target SAR image does not contradict the prediction value constituting the simulated SAR image.

4. The signal processing apparatus according to claim 3, wherein
each of the evaluation indices is a posterior probability that the observation value is observed for each corresponding pixel in the simulated SAR image and the target SAR image, and
obtaining the evaluation index includes obtaining the evaluation index for each corresponding pixel by using the simulation information and the target SAR image.

5. The signal processing apparatus according to claim 3, wherein
each of the evaluation indices is a simultaneous probability that the observation value is observed for each corresponding pixel in the simulated SAR image and a plurality of target SAR images, and
obtaining the evaluation index includes
obtaining a posterior probability that the observation value is observed for each corresponding pixel by using the simulation information and each of the plurality of target SAR images, and
obtaining the evaluation index for each corresponding pixel by combining posterior probabilities obtained by using each of the plurality of target SAR images for each corresponding pixel.

6. The signal processing apparatus according to claim 3, wherein
each of the evaluation indices is a simultaneous probability that the observation value is observed for each corresponding pixel group in the simulated SAR image and the target SAR image, and
obtaining the evaluation index includes
obtaining a posterior probability that the observation value is obtained for each corresponding pixel by using the simulation information and the target SAR image, and
obtaining the evaluation index for each corresponding pixel group by combining posterior probabilities obtained for each of pixels constituting the pixel group for each corresponding pixel group.

7. The signal processing apparatus according to claim 1, wherein
the processor configured to further execute the instructions to:
detect a change in the target region by using the evaluation index.

8. The signal processing apparatus according to claim 1, wherein
the processor configured to further execute the instructions to:
generate, by using a plurality of observed SAR images, three-dimensional information with reliability including three-dimensional information including an estimated value of each of a reflection intensity and a phase for each of three-dimensional elements constituting the target region, and estimation reliability information indicating reliability of the estimated value of each of the three-dimensional elements, and
generating simulation information includes generating the simulation information by using the three-dimensional information with reliability and an observation condition in a case where the actual measured value is observed.

9. A signal processing method comprising:
by one or more computers,
generating simulation information including a simulated SAR image formed from a prediction value of each pixel predicted to be obtained in a case where a target region in a steady state is observed, and prediction reliability information indicating reliability of the prediction value of each pixel; and
obtaining an evaluation index obtained by evaluating a target SAR image that is an analysis target, by using the simulation information.

10. A non-transitory computer readable medium recording a program for causing one or more computers to execute:
generating simulation information including a simulated SAR image formed from a prediction value of each pixel predicted to be obtained in a case where a target region in a steady state is observed, and prediction reliability information indicating reliability of the prediction value of each pixel; and
obtaining an evaluation index obtained by evaluating a target SAR image that is an analysis target, by using the simulation information.
